(19) United States
(12) Patent Application Publication
(10) Pub. No.: US 2003/0012699 A1
(43) Pub. Date: Jan. 16, 2003

(54) Simultaneous handling of magnetic beads in a two-dimensional arrangement

(76) Inventors: Thomas Moore, Drackendorf Stadt Jena (DE); Peter Zimmermann, Kahla (DE)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/172,560

(22) Filed: Jun. 13, 2002

Related U.S. Application Data
(63) Continuation-in-part of application No. 09/442,562, filed on Nov. 18, 1999, now abandoned.

(30) Foreign Application Priority Data
Nov. 18, 1998 (DE) 198 54 003.5

(51) Int. Cl. B01L 9/00; B01L 3/02

(52) U.S. Cl. 422/100; 422/104

(57) ABSTRACT

An arrangement for handling and selective magnetic filed directed horizontally magnetic rinsing of particles and liquids, magnetic beads and vessels, comprises a two-dimensional pipette arrangement, a two-dimensional magnet holder arrangement and a two-dimensional arrangement of cavities. The arrangements are in combination with a handling mechanism.

This is a continuation-in-part application of application Ser. No. 09/442,562 filed Nov. 18, 1999 which claims foreign priority to German application DE 198 54 003.5 filed Nov. 18, 1998 both of which are hereby incorporated into this specification by reference; and priority is hereby claimed herein to both of these previous applications.

### BACKGROUND OF THE INVENTION

a) Field of the Invention

Magnetic beads have been used in molecular biology/biochemistry since the end of the 1970s. In many instances, microscopically small, polymer-coated spheres which contain magnetic material in the form of, for example, iron oxide are used to secure other molecules at the surface and to transport these molecules.

The advantage of these microscopically small spheres—“magnetic beads”—consists in the huge surface area of only a few milligrams of material and the simplicity of producing homogeneous suspensions of beads which can be pipetted, metered, dispensed, diluted and mixed using standard liquid-handling appliances. The number of possible applications cannot be described in full here, being very extensive and including:

Purification of RNA/DNA products

mRNA isolation

DNA/RNA hybridization

Solid-phase sequencing

Cell separation techniques

and also standard ELISA processes can alternatively be carried out using magnetic beads, since these can be washed very well using standard laboratory equipment.

Another very important step is the concentration of suspension volumes, which is also possible by magnetic-bead binding.

b) Description of the Related Art

Various appliances are in use for separating the solid and liquid phase. For example, the DYNAL company, for an Eppendorf microcentrifuge tube, offers a holder which secures the tube using a spring and presses it against a permanent magnet, so that virtually all the magnetic beads which are in suspension move towards this magnet.

It is very easy to remove the liquid using a standard manual pipette, so that only the magnetic particles then remain behind on the wall of the vessel. If the tube is removed from the holder and is again filled with liquid, followed by thorough mixing, the beads are washed, so that ultimately only the bonded product remains on the particles. The separation of product and magnetic beads takes place in the same way as that mentioned above. The prior art also includes electrically controllable magnetic fields (DYNAL-MPC-auto 96) or permanent magnets which can be moved by means of a motor; AGOWA magnetic separator (DE-U 29614623).

The magnet holders MPC-96 or MPC-9600 produced by DYNAL can be used to handle magnetic beads in the microtitation plate format, in particular for PCR preparation work in so-called thin wall tube plates. The magnetic-bead holder MPC-9600 is also incorporated in the above-mentioned AGOWA magnetic separator. The two-part magnetic separator produced by PROMEGA also operates using the 8×12 well format. Iron pins penetrate into the microtitration plate and hold the magnetic beads in place, so that the solid phase becomes fixed to these pins. This functions for as long as the iron pins are coupled to a permanent magnet. If the latter is removed, the magnetic particles can be resuspended. To carry out screening experiments, it is important, in the microtitration plate format, to achieve a high throughput of test points per unit time. As with all liquid-handling steps, this can only be achieved by suitable automation.

For this reason, the pipetting machines which are in extremely widespread use in screening, such as for example those produced by TECAN, BECKMAN, HAMILTON and ROSYS, have been retrofitted with magnetic separators produced by AGOWA or DYNAL. However, complete test sequences (e.g. mRNA isolation from cell culture or viral IRNA from whole blood for PCR detection) still last several hours using these appliances. A characteristic feature of these machines is that they carry out the liquid-handling steps using one pipette tip or 2 to 8 pipette tips which are arranged in a one-dimensional row.

### OBJECT AND SUMMARY OF THE INVENTION

Therefore, the primary object of the invention is to propose a solution which can be automated in order to achieve a higher throughput of microtitration plates per unit time.

Such an increase in throughput can be achieved by combining the magnet holder arrangements which are compatible with microtitration plates and are known per se, and the simultaneous metering appliances with 8×12 well tips in the microtitration plate format, which are likewise known, with a correspondingly designed microtitration-plate and magnet-holder presentation mechanism. Using these devices for handling liquids and magnetic beads, which are in each case two-dimensional, with the addition of a suitably designed plate-handling system, produces a completely new tool for isolation/purification which works on the scale of minutes.

### BRIEF DESCRIPTION OF THE DRAWINGS

FIGS. 1 to 4 show two embodiment forms of arrangements according to the invention for simultaneous magnetic particle handling.

FIG. 1 shows a first embodiment form with a comb-like arrangement of permanent magnet rods as a magnet holder arrangement;

FIG. 2 shows the embodiment form according to FIG. 1 with an offset cavity arrangement;

FIG. 3 shows a third embodiment form with a magnet carrier plate as a magnet holder arrangement; and

FIG. 4 shows the embodiment form according to FIG. 3 with an offset cavity arrangement.

FIG. 5 shows a fourth embodiment with handling mechanisms for vertical and horizontal movement.

FIG. 6 shows a fifth embodiment with magnet rods 3 if different orientation.

FIG. 7 shows a sixth embodiment with handling mechanisms for vertical and horizontal movement.

FIG. 8 shows cavity arrangement 2 in a different orientation.

### DESCRIPTION OF THE PREFERRED EMBODIMENTS

The first embodiment form shown in FIG. 1 essentially comprises a two-dimensional tip arrangement 1, a two-dimensional cavity arrangement 2, a magnet holder arrangement, in this case constructed as a comb-like arrangement of permanent magnet rods 3, and a carrier plate 4.

The tip arrangement 1 comprises 96 tips, for example, (arranged in 8 lines or rows by 12 columns) which are arranged in a given grid dimension (spacing of intersections of the lines and columns).

The cavity arrangement 2 is a special, commercially available microtitration plate with a small wall thickness, whose cavities are arranged identically to the tips and which is arranged below the tip arrangement 1 in such a way that the tips are guided into the cavities and an exchange of liquid can take place.

The carrier plate 4 is a plane plate with a hole arrangement having the same grid dimension as the cavity arrangement 2 and the tip arrangement 1. The diameters of the holes are so selected with respect to size that the cavities of the cavity arrangement 2 supported on the carrier plate 4 project into the holes. However, the carrier plate 4 has an additional row of holes, so that an offset of the cavity arrangement 2 arranged on the carrier plate 4 is possible. The cavity arrangement 2 can accordingly be arranged in two different relative positions with respect to the carrier plate 4.

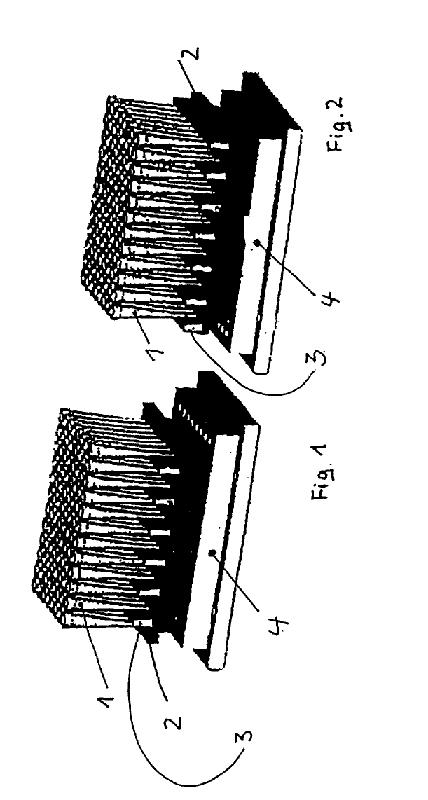

FIG. 1 and FIG. 2 show the described first embodiment form in one of the two possible relative positions. As is clear from FIG. 1 when considered in combination with FIG. 2, the permanent magnet rods 3 are located in the two relative positions, each in a position located opposite to an individual pipette tip. This is achieved in that the permanent magnet rods 3 are arranged in the column direction between every second column. By means of a handling mechanism, not shown, the permanent magnet rods 3 are guided out of and into the tip arrangement 1 in the column direction and the cavity arrangement 2 is moved in the line direction back and forth between the two relative positions. The magnetic particles of a suspension located in the cavities are therefore moved back and forth, i.e., they move to the side of the cavities where the permanent magnet rod 3 is located.

A second embodiment form not shown in the Figures differs from the first embodiment form essentially with regard to the handling mechanism. In this case, the latter is conceived in such a way that only a relative movement of the comb-like arrangement of permanent magnet rods 3 is carried out in that the latter are guided out of the tip arrangement in the column direction, subsequently displaced in the line direction and introduced into the tip arrangement again in the column direction. Since the offsetting of the cavity arrangement 2 is therefore omitted, the carrier plate 2 must also not have any additional row of holes.

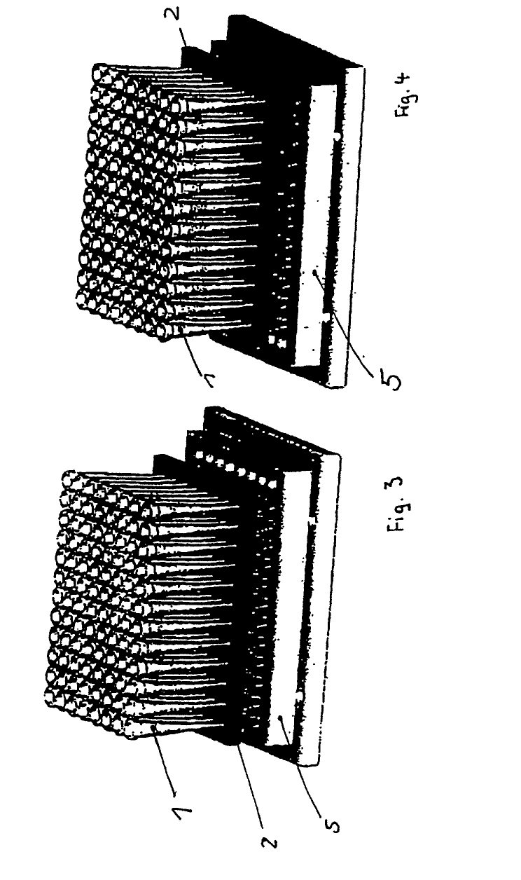

In a third embodiment form, shown in FIGS. 3 and 4, the functions that are carried out in the first and second embodiment forms of the carrier plate 4 and comb-like arrangement of permanent magnet rods 3, are taken over by a magnet carrier plate 5. The magnet carrier plate 5 resembles the carrier plate 4 only outwardly. A permanent magnet strip is introduced into the plate body between every second row of holes arranged in the column direction. In this embodiment form, the handling mechanism is designed only for the offsetting of the cavity arrangement.

The views in the individual Figures are limited to the features essential for an understanding of the invention. Accordingly, it is clear for the person skilled in the art that the tip arrangement is connected with a simultaneous dosing device and that the quantity of the tips, cavities and holes arranged in the columns and rows are adapted to one another, but can be optionally selected in principle.

In the following, the equipment technology used for this purpose, with examples of possible means, will be described:

Simultaneous metering appliance (DD Patent 260571):

These appliances allow the simultaneous uptake/dispensing of liquids in the two-dimensional 8×12 or 16×24 well grid which is standard for microtitration plates, by means of pipette tips, needles or similar devices.

Magnet holders:

Two-dimensional 8×13 hole arrangement in the microtitration plate format, which are able to accommodate, for example, the wells of so-called thin wall tube plates, and between the columns of holes or rows in which permanent magnets are arranged in such a way that, when the abovementioned plates are inserted, the magnetic beads located in the wells of the plates are attracted by these magnets and are fixed to the wall of the wells. An additional column or row on this perforated plate makes it easy, by transferring the thin wall tube plates, to fix the magnetic particles to the right-hand or left-hand side of the wells. By changing the position, it is possible to wash the particles in the liquid phase. In the following example, it is assumed that there is an additional column.

Or:

A comb arrangement of permanent-magnet bars, oriented in rows or columns, the distance between which allows them to be positioned between the pipette tips of the simultaneous metering appliance. In this way, it is possible to hold the magnetic beads in the pipette tip and to take up or dispense liquid.

Thin wall tube plates (TWP):

Special 8×12=96 well microtitration plates (192 and 384 well also standard) of small wall thickness, usually made from polypropylene PP or polycarbonate PC, which are usually dimensioned in such a way that they are used in standard commercial thermocyclers, and thus provide the possibility of also being positioned in a perforated plate with magnets.

Microtitration plate and magnet-holder handling mechanism:

Device for positioning microtitration plates (MTPs), TWPs and storage and washing vessels in relation to a magnet holder, and also for positioning the magnet holder in relation to a two-dimensional pipette tip arrangement which is in the form of a matrix, in such a manner that it is possible, for example, to deposit TWPs alternately, beginning with column 1 or 2, in the magnet holder or to position a magnet holder with respect to the pipette tips, with, in a first variant, means for picking up the TWPs or other vessels with a geometry similar to that of microtitration plates from a conveyor device and putting them down on the magnet holder, and positioning the latter with respect to the pipette tips in such a manner that, with a pipette-tip arrangement in the form of a matrix, it is possible to exchange liquid between tips and cavities.

Alternatively, in a second variant, a magnetic comb is arranged between the tips in such a way that the magnetic comb is arranged alternately, beginning in the first or second row of tips, and it becomes possible to exchange liquid between pipette tips and the cavities of the microtitration plate.

The means for achieving the above technical object can be described as follows:

To move the microtitration plates and the magnetic holder in the vertical direction, a suitable motor drive, e.g. in the form of a rack drive with a stepper motor, is provided. Positioning in the two horizontal directions is effected using an electrically controllable mechanical stage. The plates can be fixed beneath the pipette tips using a gripper mechanism. The plates are transported to the simultaneous metering appliance by means of a carriage, for example on a rod guide mechanism. To move the magnet holders between the pipette tips, a horizontally running linear drive is provided, which pulls the magnets out of the space between the tips and pushes them back in a position which has been shifted by one grid. The prior art reveals all these drive and handling means. It is easy to use a computer control system to automate these various sequences of movements.

A simple sequence for washing the beads is described below:

The particles are in a homogeneous suspension in a TWP and have, for example, nucleic acid bonded to their surface. By inserting the thin wall plates into the magnetic adaptor, the beads are fixed to the walls of the wells, and the two-dimensional pipette arrangement can be used to remove the liquid phase and, at the same time, to add washing solutions from a reservoir which may, inter alia, be a MTP or a similar vessel. As a result of the position of the plate being changed by one column with respect to the magnets, the particles move from one side of the well to the other and are washed. This operation can be supplemented outside the magnet holder by the simultaneous suction/dispensing of the liquid, including the beads, using the two-dimensional pipette tip arrangement.

Working with such an arrangement leads to a considerable increase in the processing rate, so that it becomes possible to carry out the purification of nucleic acids, using adding reagents, lyses, elution and addition of the PCR mix, within a few minutes.

One main difference with respect to the prior art is that a horizontal relative movement between the vessels containing the suspension and the magnet holder arrangement or magnets, by a path length equal to the spacing between the rows of holes is carried out by means of a microtitration plate and magnet-holder handling mechanism. The permanent magnets are accordingly placed to the right of the row on the one hand and to the left of the row on the other hand with respect to the vessels arranged in a row. Accordingly, the opposite sides of the vessels alternatively come into the sphere of influence of a magnetic field, so that the magnetic particles are alternatively drawn into the vessel wall. Thus, the magnetic particles move in the vessels by traversing them substantially horizontally.

In this way, the rinsing effect achieved is appreciably higher than when the magnetic particles move by means of a vertical relative movement as in the art between the vessels and the magnets using gravity and a more limited magnetic field.

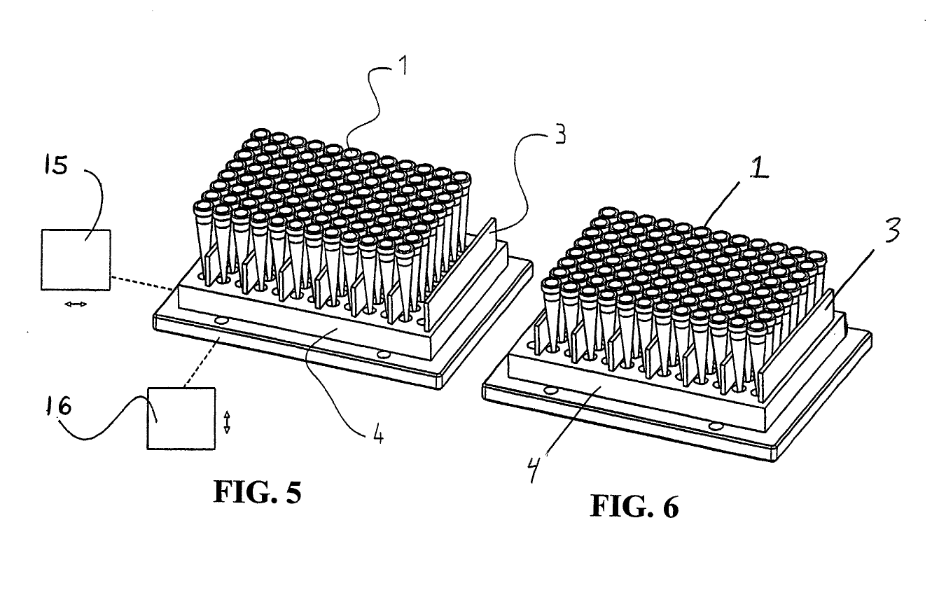

This horizontal rinsing feature is also described in FIGS. 5 and 6 where it is clear that a relative offset by a row distance between the vessels is shown by comparing the first position of the pipettes in FIG. 5 to the second position shown in FIG. 6, i.e., an offset of one row position.

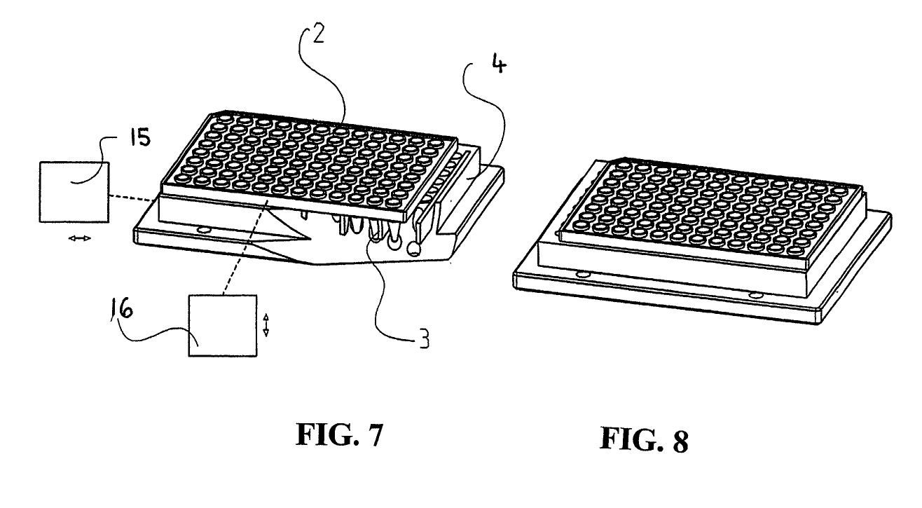

FIGS. 5, 6, 7, 8 show possible relative positions alternatively occupied by the vessels, tips 1 of an automatic multipipetter and wells of the microtitration plate 2 and the strip magnets 3 which are either fastened t the surface of the carrier plate or project at least partially in a comb-like manner from the carrier plate 4. In FIGS. 7 and 8 the strip magnets 3 are completely embedded in the carrier plate 4. In the invention means are provided for transporting, i.e., a vertical movement device 6 which raises and lowers the carrier plate 4 and the microtitration plate 2 so that the vessels and the associated holes in the carrier plate 4 engage and disengage with one another and a horizontal movement device 5 which makes possible a relative offset between the rows of vessels and the strip magnets 3 by a row spacing. The transporting means may be any suitable device including motorized movement means. In sum, said arrangements in combination with handling mechanism for a horizontal movement are connected to at least one of said arrangements to alternatively direct a magnetic field into a predetermined side of pipettes arranged in the pipette arrangement or a predetermined side of the cavities to provide a controllable horizontal resultant rinsing motion for particles in the liquid.

While the foregoing description and drawings represent the preferred embodiments of the present invention, it will be obvious to those skilled in the art that various changes and modifications may be made therein without departing from the true spirit and scope of the present invention.

What is claimed is:

1. An arrangement for handling liquids, magnetic beads and vessels, comprising:
a two-dimensional pipette arrangement for pipetting liquid from a two-dimensional arrangement of cavities;
a two-dimensional magnet holder arrangement arranged proximate to the two-dimensional pipette arrangement and the two-dimensional arrangement of cavities; and
said arrangements in combination with handling mechanism for a horizontal movement connected to at least one of said arrangements to alternatively direct a magnetic field into a predetermined side of pipettes arranged in the pipette arrangement or a predetermined side of the cavities to provide a controllable horizontal resultant rinsing motion for particles in the liquid.

2. The arrangement according to claim 1, wherein the two-dimensional pipette arrangement is a simultaneously operating automatic pipetting/metering appliance with at least four tips/needles.

3. The arrangement according to claim 1, wherein the two-dimensional magnet holder arrangement is a carrier plate for a multiplicity of permanent magnets which are arranged in the form of a geometric matrix.

4. The arrangement according to claim 1, wherein the two-dimensional magnet holder arrangement is a carrier plate for a multiplicity of permanent-magnet bars which are arranged in rows.

5. The arrangement according to claim 1, wherein the two-dimensional magnet holder arrangement is a carrier plate for a multiplicity of permanent-magnet bars which are arranged in columns.

6. The arrangement according to claim 1, wherein the two-dimensional magnet holder arrangement is a comb-like arrangement of permanent-magnet bars.

7. The arrangement according to claim 1, wherein the two-dimensional arrangement of cavities is oriented to the microtitration plate format.

8. The arrangement according to claim 2, wherein the geometric arrangement of the tips/needles follows a standard microtitration plate format.

9. The arrangement according to claim 3, wherein the arrangement of the permanent magnets is oriented to the cavities of the microtitration plate.

10. The arrangement according to claim 6, wherein the grid of the comb arrangement results from the grid of tips of the simultaneous metering appliance, so that the magnet bars fit into the spaces between the tips.
